(19) United States
(12) Patent Application Publication
(10) Pub. No.: US 2026/0129176 A1
(43) Pub. Date: May 7, 2026

(54) ELECTRONIC DEVICE AND METHOD OF PROVIDING 3D IMAGE

(71) Applicant: SAMSUNG ELECTRONICS CO., LTD., Suwon-si (KR)

(72) Inventors: Hwasun LEE, Suwon-si (KR); Yeongjun KWON, Suwon-si (KR); Gyumin KIM, Suwon-si (KR); Beomsoo KIM, Suwon-si (KR); Jaeeon PARK, Suwon-si (KR); Minjae SHIN, Suwon-si (KR); Huijun SHIM, Suwon-si (KR); Gucheol JEONG, Suwon-si (KR); Hyunjun CHO, Suwon-si (KR)

(73) Assignee: SAMSUNG ELECTRONICS CO., LTD., Suwon-si (KR)

(21) Appl. No.: 19/319,171

(22) Filed: Sep. 4, 2025

Related U.S. Application Data
(63) Continuation of application No. PCT/KR2025/012070, filed on Aug. 8, 2025.

(30) Foreign Application Priority Data
Nov. 1, 2024 (KR) 10-2024-0153794

(51) Int. Cl. H04N 13/354; H04N 13/117; H04N 13/133; H04N 13/15; H04N 13/324

(52) U.S. Cl. CPC H04N 13/354; H04N 13/117; H04N 13/133; H04N 13/15; H04N 13/324

(57) ABSTRACT

An electronic device includes a display configured to provide a multi-view image including a plurality of images viewable from different viewpoints, a sensor, a memory to store instructions, and at least one processor including processing circuitry, to execute the instructions, individually or collectively, to cause the electronic device to identify a viewing position of a user based on sensing data obtained through the sensor, identify an image with a viewpoint corresponding to the viewing position of the user among the plurality of images viewable from the different viewpoints, obtain an output image by adjusting a brightness of remaining viewpoint images excluding images viewable from some viewpoints including the identified image, and display the output image on the display.

### CROSS-REFERENCE TO RELATED APPLICATION

This application is a continuation application is a continuation application, under 35 U.S.C. § 111(a), of international application No. PCT/KR2025/012070, filed on Aug. 8, 2025, which claims priority under 35 U. S. C. § 119 to Korean Patent Application No. 10-2024-0153794, filed on Nov. 1, 2024, the disclosures of which are incorporated herein by reference in their entireties.

### BACKGROUND

### 1. Field

One or more embodiments of the present disclosure relate to an electronic device, and for example, to an electronic device that renders and provides a 3D image and a method of providing the 3D image.

### 2. Description of the Related Art

The purpose of display technology is to deliver information about natural three-dimensional spaces or virtual environments to humans more accurately and realistically. To create an experience as if one is actually present at the scene, various types of 3D imaging technologies have been developed to provide natural and realistic screens. 3D display technologies are generally classified into glasses-based and glasses-free systems, including stereoscopic 3D displays (e.g., two-view systems using glasses), multi-view displays, and holographic 3D displays. Due to the discomfort caused by wearing 3D glasses, there has been active research into glasses-free 3D display technologies.

Existing stereoscopic 3D displays include two viewpoint image information that can view stereoscopic images, and there is a problem that the viewpoint changes discontinuously due to the limitation of the field of view, causing eye fatigue and dizziness due to unnatural motion parallax and focus-convergence mismatch. Viewpoint images refer to images when a user views a 3D display in an actual physical space. Various methods for securing a viewing angle are being studied to improve these two problems. From a hardware perspective, research is being conducted on a multi-viewpoint method that can show a more natural 3D effect by attempting to increase the number of viewpoints, and from a software perspective, a rendering method that tracks the user's position and rearranges pixels appropriately for that position to provide an optimal 3D stereoscopic image according to the user's position is being studied.

The above information may be provided as related art for the purpose of assisting in understanding the present disclosure. No claim or determination is made as to whether any of the above is applicable as prior art related to the present disclosure.

### SUMMARY

An electronic device according to an embodiment includes a display configured to provide a multi-view image including a plurality of images viewable from different viewpoints, a sensor, a memory to store instructions, and at least one processor including processing circuitry, to execute the instructions, individually or collectively, to cause the electronic device to identify a viewing position of a user based on sensing data obtained through the sensor, identify an image with a viewpoint corresponding to the viewing position of the user among the plurality of images viewable from the different viewpoints, obtain an output image by adjusting a brightness of remaining images excluding images viewable from some viewpoints including the identified image, and display the output image on the display.

According to an embodiment, the multi-view image may include the plurality of images viewable from the different viewpoints which are sequentially and repeatedly arranged. The at least one processor executes the instructions, individually or collectively, may cause the electronic device to adjust a brightness of remaining images excluding the identified image.

According to an embodiment, the instructions, the at least one processor executes the instructions, individually or collectively, may cause the electronic device to obtain the output image by adjusting a brightness of the remaining images so that the brightness of the remaining images excluding the identified viewpoint image is reduced.

According to an embodiment, the at least one processor executes the instructions, individually or collectively, may cause the electronic device to obtain the output image by adjusting a brightness of the remaining images so that the brightness gradually decreases in proportion to a distance from the identified image.

According to an embodiment, the instructions, the at least one processor executes the instructions, individually or collectively, may cause the electronic device to obtain the output image by adjusting a brightness of the remaining images so that the brightness gradually decreases based on a weight that decreases according to a distance from the identified image, and a degree of decrease in the weight may increase in proportion to a distance from the identified image.

According to an embodiment, the instructions the at least one processor may execute the instructions, individually or collectively, may cause the electronic device to convert the remaining images from RGB color space images to YUV color space images, maintain U and V values and adjust a Y value in the YUV color space images, and reconvert the YUV color space images with the adjusted Y value to RGB color images, and obtain the output image based on the reconverted RGB color space images.

According to an embodiment, the instructions, the at least one processor may execute the instructions, individually or collectively, may cause the electronic device to output the output image by performing a blurring process while adjusting a brightness of the remaining images excluding some viewpoints including the identified image.

According to an embodiment, the at least one processor may execute the instructions, individually or collectively, may cause the electronic device to, based on a private mode being selected, obtain the output image by adjusting a brightness of remaining images excluding some viewpoints including the identified image.

According to an embodiment, the at least one processor may execute the instructions, individually or collectively, may cause the electronic device to provide a user interface (UI) to allow a viewing angle to be set, and identify remaining images excluding the identified image based on the viewing angle set through the UI in the private mode.

According to an embodiment, the display may include a display panel configured to display the multi-view image including a plurality of images viewable from the different viewpoints, and a viewing area separator to be disposed in front of the display panel and configured to provide an optical view corresponding to different viewpoints for each viewing area.

A controlling method of an electronic device may include a display configured to provide a multi-view image including a plurality of viewable from different viewpoints. According to an embodiment includes identifying a viewing position of a user based on sensing data obtained through a sensor, identifying an image corresponding to a viewing position of the user among a plurality of images viewable from the different viewpoints, obtaining an output image by adjusting a brightness of remaining images excluding images viewable from some viewpoints including the identified image, and displaying the output image on the display.

According to an embodiment, a non-transitory computer readable recording medium storing a computer instruction executable by a processor of an electronic device including a display configured to provide a multi-view image including a plurality of images viewable from different viewpoints to cause the electronic device to identify a viewing position of a user based on sensing data obtained through a sensor, identify an image with a viewpoint corresponding to a viewing position of the user among a plurality of images viewable from the different viewpoints, obtain an output image by adjusting a brightness of remaining images excluding images viewable from some viewpoints including the identified image, and display the output image on the display.

### BRIEF DESCRIPTION OF THE DRAWINGS

The above and other aspects and features of specific embodiments of the present disclosure are set forth in the accompanying drawings, which will become clearer in the following explanation taken together:

FIG. 1 is a view provided to explain an operation of an electronic device according to one or more embodiments;

FIG. 2 is a block diagram of an electronic device according to an embodiment;

FIG. 3 is a view provided to explain an implementation example of a display according to an embodiment;

FIG. 4 is a flowchart provided to explain a 3D image providing method according to an embodiment;

FIG. 5 is a view provided to explain an example of a 3D image providing method according to an embodiment;

FIG. 6 is a view provided to explain an operation method of an electronic device for providing a 3D image according to an embodiment;

FIG. 7 is a view provided to explain a method of providing an optical view according to an embodiment; and

FIGS. 8A, 8B to 8C are views provided to explain a brightness adjustment method of an optical view according to an embodiment.

### DETAILED DESCRIPTION

General terms that are currently widely used are selected as the terms used in embodiments of the disclosure in consideration of their functions in the disclosure, and may be changed based on the intention of those skilled in the art or a judicial precedent, the emergence of a new technique, or the like. In addition, in a specific case, terms arbitrarily chosen by an applicant may exist, and in this case, the meanings of such terms are mentioned in detail in corresponding descriptions of the disclosure. Therefore, the terms used in the embodiments of the disclosure need to be defined on the basis of the meanings of the terms and the contents throughout the disclosure rather than simple names of the terms (analyzing calls, messages, schedules, etc.).

In the disclosure, the expressions “have”, “may have”, “include” or “may include” used herein indicate existence of corresponding features (e.g., elements such as numeric values, functions, operations, or components), but do not exclude presence of additional features.

An expression, “at least one of A or/and B” may indicate either “A or B”, or “both of A and B.”

Expressions “first”, “second”, “1st,” “2nd,” or the like, used in the disclosure may indicate various components regardless of sequence and/or importance of the components, will be used only in order to distinguish one component from the other components, and do not limit the corresponding components.

When it is described that an element (e.g., a first element) is referred to as being “(operatively or communicatively) coupled with/to” or “connected to” another element (e.g., a second element), it should be understood that it may be directly coupled with/to or connected to the other element, or they may be coupled with/to or connected to each other through an intervening element (e.g., a third element).

Singular expressions include plural expressions unless the context clearly dictates otherwise. In this specification, terms such as “comprise” or “have” are intended to designate the presence of features, numbers, steps, operations, components, parts, or a combination thereof described in the specification, but are not intended to exclude in advance the possibility of the presence or addition of one or more of other features, numbers, steps, operations, components, parts, or a combination thereof.

In exemplary embodiments, a ‘module’ or a ‘unit’ may perform at least one function or operation, and be implemented as hardware or software or be implemented as a combination of hardware and software. In addition, a plurality of ‘modules’ or a plurality of ‘units’ may be integrated into at least one module and be implemented as at least one processor except for a ‘module’ or a ‘unit’ that needs to be implemented as specific hardware.

In this specification, the term ‘user’ may refer to a person using an electronic device or a device using an electronic device (e.g., an artificial intelligence electronic device).

Meanwhile, various elements and regions in the drawings are schematically drawn in the drawings. Therefore, the technical concept of the disclosure is not limited by a relative size or spacing drawn in the accompanying drawings.

Hereinafter, an embodiment of the present disclosure will be described in detail with reference to the accompanying drawings.

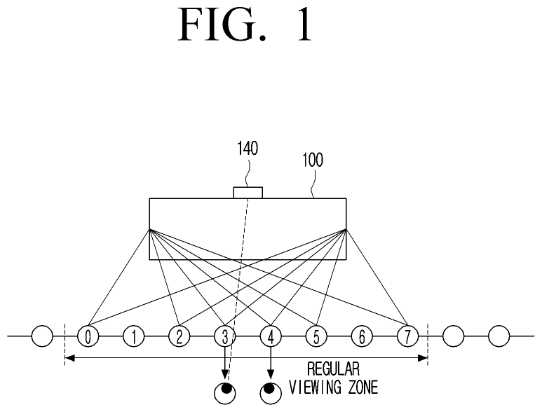

FIG. 1 is a view provided to explain an operation of an electronic device according to one or more embodiments.

According to an embodiment, an electronic device 100 may be implemented as various types of display devices such as a TV, a monitor, a kiosk, a tablet PC, an electronic picture frame, a mobile phone, a large format display (LFD), a digital signage, a digital information display (DID), a video wall, a projector display, etc. However, in some cases, the electronic device 100 may be implemented as an image processing device (e.g., a set-top box, one connected box) that is connected to a display device and provides an image.

According to an embodiment, the electronic device 100 may be implemented as a glasses-free 3D display device based on user location tracking. For example, the electronic device 100 may track the location of the user's eyes or head in real time to provide an optimized 3D image. For example, the electronic device 100 may identify the user's viewing position in real time based on data obtained through a sensor 140 capable of tracking the user's viewing position in real time. For example, the sensor 140 may include at least one of an RGB camera or a depth camera.

In one example, the electronic device 100 may identify the user's real-time viewing position by calibrating a photographing image obtained through a camera. The calibration may be a process of estimating internal and external parameters of the camera to convert 3D world coordinates into 2D image coordinates.

According to another embodiment, the electronic device 100 may generate and provide multi-view images based on the user's real-time viewing position. For example, the electronic device 100 may obtain a multi-view image in which a plurality of viewpoint images are arranged according to a Linear Mapping method. The Linear Mapping method may generate a multi-view image by sequentially and repeatedly arranging a preset number of viewpoint images. For example, the electronic device 100 may generate a multi-view image such that viewpoint images from viewpoint 0 to viewpoint 7 are mapped to the optical view in the order of 0, 1, 2, 3, 4, 5, 6, 7, 0, 1, 2, 3 . . . according to a Linear Mapping method. In this case, the zone where 0, 1, 2, 3, 4, 5, 6, and 7 are arranged in an ascending order may correspond to a regular viewing zone. The optical view may be a visual image provided in the user's viewing area through optical means. For example, the electronic device 100 may use OpenG1 for multi-view image rendering, and use commercial library FaceAPI for user face tracking.

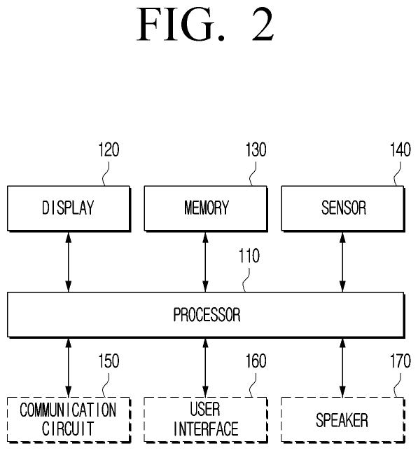

According to an embodiment, when 3D content is activated, there may be cases where a user wishes to view display information without exposing it to others when using a personal display. Accordingly, hereinafter, various embodiments of a private mode that limits the viewing zone of a 3D display by adjusting the brightness of an image based on identifying the user's viewing position and providing an optimal viewing zone to the user, will be described. FIG. 2 is a block diagram of an electronic device according to an embodiment.

Referring to FIG. 2, the electronic device 100 according to an embodiment may include a processor 110, a display 120, memory 130, a sensor 140, a communication circuit 150, a user interface 160, and a speaker 170. Even if some of the components illustrated in FIG. 2 are omitted or replaced, one or more embodiments of the present disclosure may be implemented. At least some of the illustrated components may be operatively, electrically, and/or functionally connected to each other.

In one embodiment, the hardware of the electronic device 100 being operatively connected may mean that a direct connection or an indirect connection between the hardware is established, either wired or wireless, so that the second hardware is controlled by the first hardware among the hardware. Although illustrated based on different blocks, the embodiment is not limited thereto, and some of the hardware of FIG. 2 (e.g., at least a portion of the processor 110, the memory 130 and the display 120) may be included in a single integrated circuit such as a system on a chip (SoC). The type and/or number of hardware included in the electronic device 100 is not limited to that illustrated in FIG. 2. For example, the electronic device 100 may include only some of the hardware components illustrated in FIG. 2

According to an embodiment, the processor 110 of the electronic device 100 may include hardware for processing data based on one or more instructions. The hardware for processing data may include, for example, an arithmetic and logic unit (ALU), a floating point unit (FPU), a field programmable gate array (FPGA), a central processing unit (CPU), and/or an application processor (AP). The number of processors 110 may be one or more. For example, the processor 110 may have a multi-core processor structure such as a dual core, a quad core, or a hexa core.

The processor 110 may control the operations of the electronic device 100 by executing instructions stored in the memory 130. For example, the processor 110 may correspond to multiple processors that collectively perform multiple operations by dividing them among the processors.

The CPU is a generic-purpose processor which may perform not only general calculations but also artificial intelligence calculations, and may efficiently execute complex programs through a multi-layered cache structure. The CPU may be advantageous for a serial processing method that enables organic linkage between the previous calculation result and the next calculation result through sequential calculation. The generic-purpose processor is not limited to the above examples except for a case where the processor is specified as the above-mentioned CPU.

The GPU is a processor for large-scale operations such as floating-point operations used for graphics processing, and may perform the large-scale operations in parallel by integrating a large number of cores. In particular, the GPU may be advantageous for a parallel processing method such as a convolution operation or the like, compared to the CPU. In addition, the GPU may be used as a co-processor to supplement a function of the CPU. The processor for the large-scale operations is not limited to the above example except for a case where the processor is specified as the above-mentioned GPU.

The NPU is a processor specialized in artificial intelligence calculation using an artificial neural network, and each layer constituting the artificial neural network may be implemented as hardware (e.g., silicon). In this case, the NPU is specially designed based on requirements of a company, and may thus have a lower degree of freedom compared to the CPU or the GPU, but the NPU may efficiently process the artificial intelligence calculation required by the company. Meanwhile, as the processor specialized for the artificial intelligence calculation, the NPU may be implemented in various forms such as a tensor processing unit (TPU), an intelligence processing unit (IPU), or a vision processing unit (VPU). The artificial intelligence processor is not limited to the above example except for a case where the processor is specified as the above-mentioned NPU.

According to an embodiment, the memory 130 of the electronic device 100 may include a hardware component for storing data and/or instructions input and/or output to/from the processor 110. The memory 130 may be implemented in the form of memory embedded in the electronic device 100′ or in the form of memory detachable from the electronic device 100 depending on the data storage purpose. For example, in the case of data for driving the electronic device 100, the data may be stored in the memory embedded in the electronic device 100, and in the case of data for the expansion function of the electronic device 100, the data may be stored in the memory detachable from the electronic device 100. Meanwhile, the memory embedded in the electronic device 100 may be implemented as at least one of a volatile memory (e.g. a dynamic RAM (DRAM), a static RAM (SRAM), or a synchronous dynamic RAM (SDRAM)), or a non-volatile memory (e.g., a one-time programmable ROM (OTPROM), a programmable ROM (PROM), an erasable and programmable ROM (EPROM), an electrically erasable and programmable ROM (EEPROM), a mask ROM, a flash ROM, a flash memory (e.g. a NAND flash or a NOR flash), a hard drive, or a solid state drive (SSD)). The memory detachable from the electronic device 100 may be implemented in the form of a memory card (e.g., a compact flash (CF), a secure digital (SD), a micro secure digital (Micro-SD), a mini secure digital (Mini-SD), an extreme digital (xD), or a multi-media card (MMC)), an external memory connectable to a USB port (e.g., a USB memory), or the like.

According to an embodiment, one or more instructions (or commands) representing computations and/or operations to be performed on data by the processor 110 may be stored in the memory 130 of the electronic device 100. A set of one or more instructions may be referred to as firmware, an operating system, a process, a routine, a sub-routine, and/or an application. For example, the electronic device 100 and/or the processor 110 may perform various operations when a set of a plurality of instructions distributed in the form of an operating system, firmware, a driver, and/or an application is executed. Hereinafter, the fact that an application is installed in the electronic device 100 may mean that one or more instructions provided in the form of an application are stored in the memory 130 of the electronic device 100, and that the one or more applications are stored in a format executable by the processor 110 of the electronic device 100 (e.g., a file with an extension specified by the operating system of the electronic device 100).

The at least one processor 110 controls input data to be processed according to predefined operation rules or artificial intelligence models stored in the memory 130. The predefined operation rules or artificial intelligence models are characterized by being created through training. Here, ‘being created through training’ means that the predefined operation rules or artificial intelligence models with desired characteristics are created by applying a learning algorithm to a large number of learning data. Such training may be performed in the device itself on which the artificial intelligence according to the present disclosure is performed, or may be performed through a separate server/system.

An artificial intelligence model may consist of a plurality of neural network layers. At least one layer has a plurality of weight values, and calculation of layers is performed through calculation between the calculation result of the previous layer and at least one defined calculation. Examples of the neural network include Convolutional Neural Network (CNN), Recurrent Neural Network (RNN), Deep Neural Network (DNN), Restricted Boltzmann Machine (RBM), Deep Belief Network (DBN), Bidirectional Recurrent Deep Neural Network (BRDNN), Deep Q-Networks, Transformer, but is not limited thereto unless otherwise specified.

The learning algorithm is a method of training a preset target device (e.g., a robot) by using a large number of learning data for the preset target device to make a decision or a prediction by itself. The learning algorithms may include, for example, a supervised learning algorithm, an unsupervised learning algorithm, a semi-supervised learning algorithm, or a reinforcement learning algorithm, but the learning algorithm of the disclosure is not limited to the above-described examples unless specified otherwise.

According to an embodiment, the display 120 of the electronic device 100 may output visualized information to the user. For example, the display 120 may be controlled by a controller such as a graphic processing unit (GPU) to output visualized information to the user. The display 120 may include Light Emitting Diodes (LED), micro LED, Mini LED, Organic Light Emitting Diodes (OLED) display, Liquid Crystal Display (LCD), Plasma Display Panel (PDP), Quantum dot (QD) display, and/or Quantum dot light-emitting diodes (QLED). According to an embodiment, the display 120 may be implemented as a flat display, a curved display, a foldable and/or rollable flexible display.

According to an embodiment, the display 120 may be implemented as a 3D 3-dimensional (3D) display that provides a 3D image to the user. For example, the display 120 may include a structure such as a lenticular lens or a parallax barrier that is arranged on the front of a display panel including a plurality of pixels.

According to an embodiment, the sensor 140 of the electronic device 100 may sense various information. The sensor 140 may be implemented as various types of sensors.

According to an embodiment, the sensor 140 may include a camera. The camera may photograph a subject in the surroundings, convert the image information into digital data, and provide it to the processor 110. The electronic device 100 may include at least one camera on the front side, which includes the display 120, and/or on the rear side, which is opposite to the front side. According to an embodiment, the camera may include a lens assembly that includes at least one lens for collecting light emitted from an external environment (or subject), an image sensor (e.g., a charged coupled device (CCD) sensor or a complementary metal oxide semiconductor (CMOS) sensor) that converts the collected light into electrical signals to generate image data, and an image signal processor that performs various processing operations on the image data obtained from the image sensor. At least some of the above-described configurations of the camera may be omitted or replaced with other configurations. The camera may provide images capturing the external environment to the processor 110 in real time through an interface (e.g., mobile industry processor interface). For example, the camera may include at least one of an RGB camera, an ultra-wide-angle camera, a depth camera, or an IR (infrared) camera.

According to an embodiment, the sensor 140 may include at least one of a time of flight (ToF) sensor, an ultrasonic sensor, a radio detection and ranging (RADAR) sensor, a photodiode sensor, a proximity sensor, a passive infrared sensor (PIR) sensor, a pin hole sensor, a pin hole camera, an infrared human body detection sensor, a complementary metal oxide semiconductor (CMOS) image sensor, a heat detection sensor, a light sensor, or a motion detection sensor.

The sensor 140 may include a touch sensor configured to detect touch operations, and may be implemented in the form of a touch film, touch sheet, or touch pad.

The sensor 140 may further include at least one sensor capable of sensing ambient light intensity, ambient temperature, or the direction of incoming light. In this case, the sensor 140 may be implemented as a light sensor, a temperature detection sensor, or a light amount sensing layer.

The sensor 140 may further include at least one of an acceleration sensor (or a gravity sensor), a geomagnetic sensor, or a gyro sensor. For example, the acceleration sensor may be a three-axis acceleration sensor. The three-axis acceleration sensor may measure gravitational acceleration for each axis, and provide raw data to the processor 140. The geomagnetic sensor or the gyro sensor may be used to obtain posture information. Here, the posture information may include at least one of roll information, pitch information, or yaw information.

According to an embodiment, the communication circuit 150 of the electronic device 100 may include hardware for supporting transmission and/or reception of electrical signals between the electronic device 100 and an external device (e.g., a server). For example, the communication interface 150 may perform communication with an external device, an external storage medium (e.g., a USB memory), an external server (e.g., a web hard), etc. through communication methods such as Bluetooth, AP-based Wireless LAN Network (Wi-Fi), Zigbee, wired/wireless Local Area Network (LAN), Wide Area Network (WAN), Ethernet, IEEE 1394, High-Definition Multimedia Interface (HDMI), Universal Serial Bus (USB), Mobile High-Definition Link (MHL), Audio Engineering Society/European Broadcasting Union (AES/EBU), Optical, Coaxial, etc. According to an embodiment, the communication interface 150 may perform communication with other electronic apparatuses, external servers, and/or remote control devices, etc.

According to an embodiment, the user interface 160 of the electronic device 100 may be implemented as a device such as a button, a touch pad, a mouse, and a keyboard, or may be implemented as a touch screen or the like that can also perform the above-described display function and a manipulation input function together.

According to an embodiment, the speaker 170 of the electronic device 100 may be configured to output not only various audio data but also various notification sound, voice messages, and the like. The processor 110 may control the speaker 170 to output feedback or various notifications according to various embodiments of the present disclosure in the form of audio.

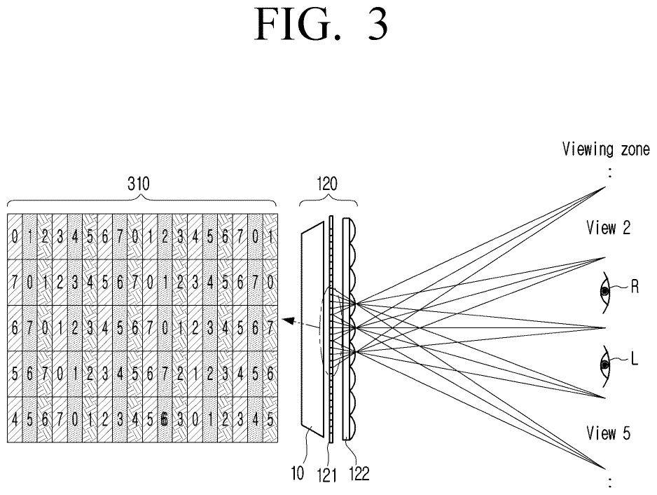

FIG. 3 is a view provided to explain an implementation example of a display according to an embodiment.

According to an embodiment, the display 120 may include a display panel and a viewing area separator.

The viewing area separator is placed on the front of the display panel to provide different viewpoints, i.e., multi-views, for each viewing area. In this case, the viewing area separator may be implemented as a lenticular lens or a parallax barrier.

For example, the viewing area separator may be implemented as a lenticular lens including a plurality of lens regions. Accordingly, the lenticular lens may refract an image displayed on the display panel through the plurality of lens regions. Each lens region may be formed to a size corresponding to at least one pixel, thereby dispersing light passing through each pixel differently for each viewing area.

As another example, the viewing area separator may be implemented as a parallax barrier. The parallax barrier is implemented as a transparent slit array including a plurality of barrier regions. Accordingly, light may be blocked through the slit between the barrier regions, so that images at different viewpoints can be output for each viewing area.

FIG. 3 illustrates an embodiment in which a viewing area separator 122 is implemented as a lenticular lens array.

According to FIG. 3, a display panel 121 includes a plurality of pixels that are divided into a plurality of columns. Pixel data corresponding to images of different viewpoints may be sequentially and repeatedly arranged in the plurality of pixels. According to an embodiment, pixel data corresponding to viewpoints 0 to 7 may be sequentially and repeatedly arranged as shown in FIG. 3. In this case, the electronic device 100 may provide an 8-viewpoint image 310. For example, the electronic device 100 may generate an output image by combining each viewpoint image in the last stage of rendering based on an index image in which viewpoint information corresponding to each pixel is recorded.

According to an embodiment, light corresponding to each viewpoint image 0, 1, 2, 3, 4, 5, 6, and 7 formed on the display panel 121 is projected onto the viewing area separator 122, and the viewing area separator 122 disperses the light of each of the projected viewpoint images 0, 1, 2, 3, 4, 5, 6, and 7 and transmits it toward the viewer. For example, the viewing area separator 122 may generate exit pupils at the viewer's position, i.e., the viewing distance. For example, as illustrated in FIG. 3, when the viewing area separator 122 is implemented as a lenticular lens array, the thickness and diameter of the lenticular lens, and when it is implemented as a parallax barrier, the spacing of the slits, etc., may be designed so that the exit pupils generated by each row are separated by an average binocular center distance of less than 65 mm. The separated image lights each form an optical view (or viewing view). For example, as shown in FIG. 3, when the first to seventh views are formed and the user's left and right eyes are positioned in the third and fourth views, respectively, a 3D image can be viewed.

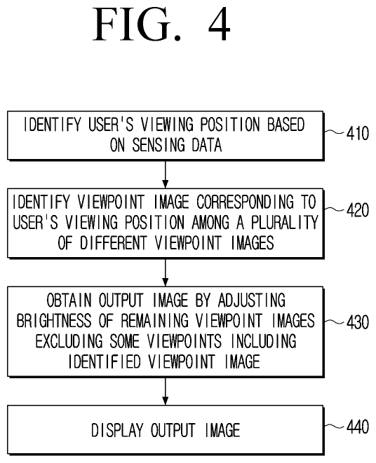

FIG. 4 is a flowchart provided to explain a 3D image providing method according to an embodiment.

Hereinafter, each operation may be performed sequentially, but may not necessarily be performed sequentially. For example, the order of each operation may be changed, and at least two operations may be performed in parallel.

According to an embodiment, it may be understood that operations 410 to 440 are performed by the processor 110 of the electronic device 100.

According to FIG. 4, in operation 410, the electronic device 100 according to an embodiment may identify the user's viewing position based on sensing data obtained through the sensor 430.

According to an embodiment, the electronic device 100 may identify at least one of the user's face (or head) or eyes in the photographing image obtained by the camera. For example, the electronic device 100 may identify an object area included in the photographing image through at least one technology among object recognition, object detection, object tracking, and image segmentation. For example, the electronic device 100 may identify the user by using a technology such as semantic segmentation that classifies and extracts objects included in the input image by type as needed, instance segmentation that recognizes objects by classifying them by type even for objects of the same type, and a bounding box in the shape of a square that includes the detected object when detecting an object included in the image.

According to an embodiment, the electronic device 100 may identify the user's face from the photographing image and identify the user's eyes from the user's face. For example, various conventional methods may be used as a face region detection method. Specifically, a direct recognition method and a method using statistics may be used. The direct recognition method creates rules using physical features such as the outline, skin color, and size of components of a face image or the distance between them, and compares, inspects, and measures according to the rules. The method using statistics may detect a face region according to a pre-learned algorithm. In other words, it is a method of digitizing the unique features included in the input face and comparing and analyzing them with a prepared large database (of faces and other object shapes). In particular, according to a pre-trained algorithm, the face region may be detected using methods such as Multi Layer Perceptron (MLP) and Support Vector Machine (SVM). A similar method may be used to identify the user's eye region.

According to an embodiment, the electronic device 100 may identify the user's eyes from the photographing image using a trained artificial intelligence model. For example, the artificial intelligence model may be implemented as a neural network including multiple neural network layers. The artificial intelligence model may be implemented as a deep neural network (DNN), a convolutional neural network (CNN), a recurrent neural network (RNN), a restricted boltzmann machine (RBM), a deep belief network (DBN), a bidirectional recurrent deep neural network (BRDNN), or deep Q-networks, but is not limited thereto.

According to an embodiment, the user's viewing location information may include at least one of the user's movement distance information and movement direction information. For example, the user's viewing location information may include movement distance information and movement direction information in a three-dimensional space using a coordinate system of the X-axis, Y-axis, and Z-axis.

In operation 420, the electronic device 100 according to an embodiment may identify a viewpoint image corresponding to the user's viewing position among a plurality of different viewpoint images. The plurality of different viewpoint images may be a plurality of images photographed or generated from different angles.

According to an embodiment, the electronic device 100 may receive a plurality of different viewpoint images from an external device (e.g., a server) or generate a plurality of different viewpoint images using various technologies. For example, the plurality of viewpoint images may be obtained through at least one of multi-camera shooting, computer graphics rendering, or image processing technology. For example, the multi-camera shooting may generate a plurality of different viewpoint images by photographing images from various angles simultaneously using multiple cameras. For example, the computer graphics rendering may generate images of various viewpoints through software based on a 3D model. For example, the image processing technology may extract depth information from one image and generate a plurality of viewpoint images based on the extracted depth information.

According to an embodiment, the electronic device 100 may identify a viewpoint image provided to the user's viewing position among a plurality of viewpoint images based on the optical structure of the viewing area separator (e.g., a lenticular lens or a parallax barrier).

In operation 430, the electronic device 100 according to an embodiment may obtain an output image by adjusting the brightness (or luminance) of the remaining viewpoint images excluding some viewpoints including the identified viewpoint image based on the user's viewing position. For example, the output image may be an image in which a plurality of different viewpoint images are arranged sequentially and repeatedly.

According to an embodiment, the electronic device 100 may adjust the brightness of the remaining viewpoint images excluding the identified viewpoint image and display them.

According to an embodiment, the electronic device 100 may adjust the brightness of the remaining viewpoint images so that the brightness of the remaining viewpoint images excluding the identified viewpoint image is reduced based on the user's viewing position.

According to an embodiment, the electronic device 100 may adjust the brightness of the remaining viewpoint images so that the brightness gradually decreases in proportion to the distance from the identified viewpoint image.

According to an embodiment, the electronic device 100 may adjust the brightness of the remaining viewpoint images so that the brightness gradually decreases based on a weight that decreases according to the distance from the identified viewpoint image based on the user's viewing position.

For example, the amount of the decrease in the weight may be the same in proportion to the distance from the identified viewpoint image. For example, the electronic device 100 may adjust the brightness of the remaining viewpoint images so that the Y value reference of the YUV image is decreased by the same size according to the distance from each viewpoint image. For example, the electronic device 100 may adjust the brightness of the remaining viewpoint images so that the Y value reference of the YUV image is decreased in the order of −10, −20, −30 according to the distance from each viewpoint image.

For example, the amount of the decrease in the weight may be increased in proportion to the distance from the identified viewpoint image. For example, the electronic device 100 may adjust the brightness of the remaining viewpoint images so that the Y value reference of the YUV image is decreased by different amounts which increase gradually according to the distance from each viewpoint image. For example, the electronic device 100 may adjust the brightness of the remaining viewpoint images so that the Y value reference of the YUV image is decreased in the order of −10, −25, −45 according to the distance from each viewpoint image.

According to an embodiment, the electronic device 100 may convert the remaining viewpoint images from a Red, Green, Blue (RGB) color space image (or RGB domain image) to a Luminance, Chrominance (YUV) color space image (or YUV domain image) to adjust the brightness of the remaining viewpoint images.

RGB is expressed as three values representing the intensity of red, green, and blue components in each channel, and in the case of an 8-bit image, each channel has a value ranging from 0 to 255, for example, (255, 0, 0) representing red, (0, 255, 0) representing green, and (0, 0, 255) representing blue. YUV is a color space composed of three components: luminance (Y) and chrominance (U and V), and Y represents the brightness component including luminance information, while U and V may have chrominance information related to color. The U and V values may indicate the difference in color between the corresponding pixel and the surrounding pixels with respect to each pixel.

According to an embodiment, the electronic device 100 may convert an RGB color space image into a YUV color space image by using at least one of a preset equation, a preset formula, a preset rule, or an algorithm. For example, the electronic device 100 may normalize an RGB value of each pixel included in the RGB color space image to a value of 0 to 1, and obtain a YUV value of each pixel according to the equation of “Y=0.299×R+0.587×G+0.114×B, U=0.492×(B−Y), V=0.877×(R−Y).”

According to an embodiment, the electronic device 100 may maintain the U value and V value in the YUV color space image, adjust the Y value (or Y signal), reconvert the YUV color space image with the adjusted Y value into an RGB color space image, and obtain remaining viewpoint images with the adjusted brightness based on the reconverted RGB color space image.

According to an embodiment, the electronic device 100 may obtain an output image based on the identified viewpoint image (RGB image) and the remaining viewpoint images in the reconverted RGB color space.

According to an embodiment, the electronic device 100 may obtain an output image by performing blurring processing while adjusting the brightness of the remaining viewpoint images excluding some viewpoints including the identified viewpoint images based on the user's viewing position. For example, the blurring may be performed in a way that reduces the difference between individual pixels by averaging the color values of surrounding pixels.

According to an embodiment, when a private mode is selected, the electronic device 100 may obtain an output image by adjusting the brightness of the remaining viewpoint images excluding some viewpoint images including the identified viewpoint images based on the user's viewing position.

According to an embodiment, the electronic device 100 may provide a UI for setting a viewable viewing angle. According to one example, the electronic device 100 may provide a UI for setting a viewable viewing angle through at least one of an angle slider, a manual input field, or viewing angle presets. According to one example, when a private mode is selected, the electronic device 100 may identify a viewpoint image for which brightness is to be adjusted among a plurality of viewpoint images based on the viewable viewing angle set through the UI.

According to an embodiment, the electronic device 100 may automatically set the optimal viewing angle by analyzing the image provided on the screen.

According to an embodiment, the electronic device 100 may automatically apply the optimized viewing angle according to at least one of the lighting or the viewing distance.

According to an embodiment, the electronic device 100 may recommend a viewing angle identified according to at least one of the screen analysis, the lighting or the viewing distance through the UI.

According to an embodiment, the electronic device 100 may provide a preview screen that simulates a situation in which brightness of an outer viewpoint of a selected viewing angle is reduced whenever a recommended viewing angle is selected.

In operation 440, the electronic device 100 according to an embodiment may display an output image obtained in operation 430 on the display 120.

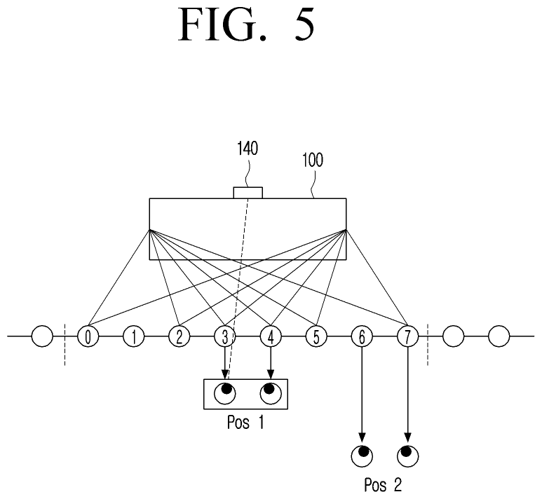

FIG. 5 is a view provided to explain an example of a 3D image providing method according to an embodiment.

According to an embodiment, the electronic device 100 may track the user's viewing position, and render and provide an optimal viewpoint image for the user's viewing position in real time. The viewpoint image may be an image that shows the present moment from a viewpoint that corresponds to a physical and real-world space. The electronic device 100 may generate a viewpoint image corresponding to each viewpoint. For example, as illustrated in FIG. 5, the electronic device 100 may provide eight viewpoint images. For example, these eight viewpoint images may be obtained by placing a virtual camera at locations defined in a three-dimensional space during the display design process and storing the scenes shown on the current screen while changing the viewpoint.

According to an embodiment, the electronic device 100 may limit the viewable viewing angle by reducing the brightness of the image provided to a position other than the user's viewing position according to the user's viewing position, as illustrated in FIG. 5. Accordingly, the viewing of the 3D image by others is limited, thereby enabling privacy protection for the 3D image. For example, a private function can be activated only when necessary by allowing the user to select the private mode only when desired.

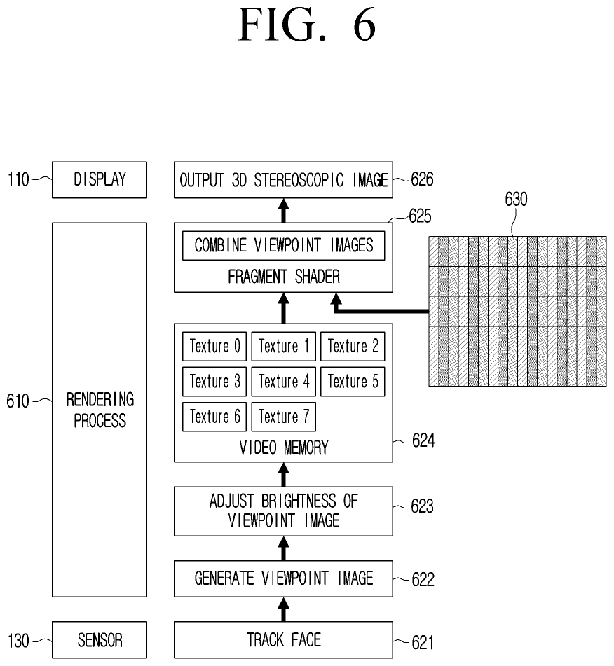

FIG. 6 is a view provided to explain an operation method of an electronic device for providing a 3D image according to an embodiment.

According to FIG. 6, the electronic device 100 may identify the user's viewing position by tracking the user's face based on a photographing image obtained through the sensor 130, for example, a camera (621).

According to an embodiment, the electronic device 100 may perform a rendering process (610) that generates an output image based on the user's viewing position.

According to an embodiment, the electronic device 100 may generate a multi-viewpoint image including a plurality of viewpoint images (622).

According to an embodiment, the electronic device 100 may identify an image corresponding to the user's viewing position among the plurality of viewpoint images based on the user's viewing position. For example, the electronic device 100 may identify two viewpoints (e.g., viewpoint 3 and viewpoint 4) corresponding to the user's left and right eyes among the eight viewpoints illustrated in FIG. 5.

According to an embodiment, the electronic device 100 may adjust the brightness of the remaining viewpoint images excluding the images corresponding to the user's viewing position (e.g., viewpoints 3 and 4 of FIG. 5) (623). For example, the electronic device 100 may be designed so that viewpoint images 3 and 4 are provided to the current user's viewing position. In this case, the electronic device 100 may adjust the brightness so that the brightness of viewpoint images 2 and 5 is gradually reduced to −10, the brightness of viewpoint images 1 and 6 is gradually reduced to −30, and the brightness of viewpoints 0 and 7 is gradually reduced to −50. Here, −10, −30, and −50 may be examples of numerical expressions of the degree of brightness adjustment for convenience of explanation.

According to an embodiment, the electronic device 100 may obtain an output image of a multi-viewpoint by combining each viewpoint image (e.g., Texture 0 to Texture 7) (624) whose brightness is adjusted and stored in a video memory (625). For example, the electronic device 100 may combine a plurality of viewpoint images (e.g., Texture 0 to Texture 7) by using a fragment shader. The fragment shader may be a shader program used to determine the final color of each pixel in graphics programming. For example, the fragment shader may be used in graphics APIs such as OpenGL and Vulkan, and may generate an output image by calculating the color of each fragment (pixel).

According to an embodiment, the electronic device 100 may combine each viewpoint image with the adjusted brightness based on an index image 630. For example, the index image 630 may be an image in which viewpoint information corresponding to each pixel is recorded as an index. For example, in the case of an 8-viewpoint image, indices from 0 to 7 may be used as viewpoint information. However, the present disclosure is not limited thereto, and the indices may be set to various values that can distinguish each viewpoint.

According to an embodiment, the electronic device 100 may output an output image obtained through the rendering process (610) to the display 110.

In the above-described embodiments, it has been described that one viewpoint image is provided to each of the user's left and right eyes, but according to an embodiment, a plurality of viewpoint images may provide one optical view provided to each of the user's left and right eyes. The optical view is a visual image provided to the user's viewing area in an optical manner, and when different optical views are provided to the user's left and right eyes, the user can view a 3D image.

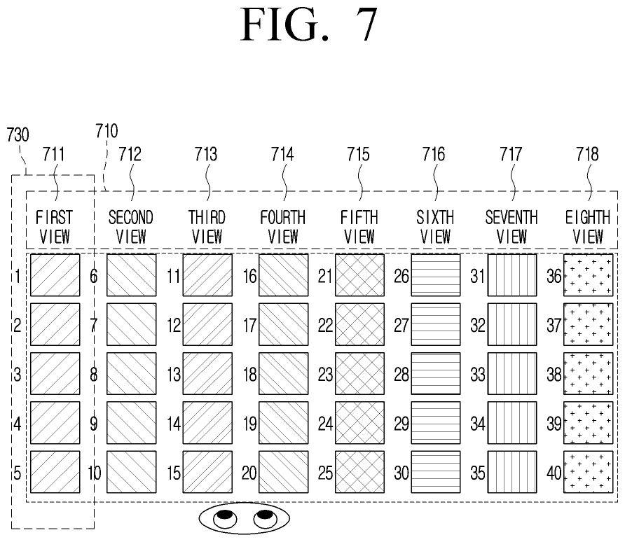

FIG. 7 is a view provided to explain a method of providing an optical view according to an embodiment.

According to an embodiment illustrated in FIG. 7, the electronic device 100 may provide eight optical views (711 to 718). According to an example, each optical view (711 to 718) may be composed of five viewpoint images (or sub-views). In other words, eight optical views (711 to 718) may be generated using a total of 40 (1 to 40) viewpoint images (720). For example, the first view (711) may be provided by synthesizing viewpoint images (or sub-views) of 1 to 5. In this case, when the parallax of adjacent optical views is A, the parallax of adjacent viewpoint images may be A/5. However, this is only an example, and the number of optical views and the number of viewpoint images constituting each optical view may vary depending on the implementation example.

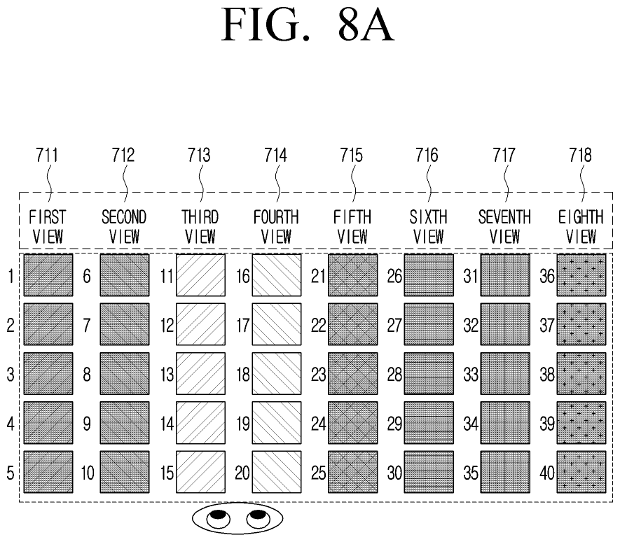

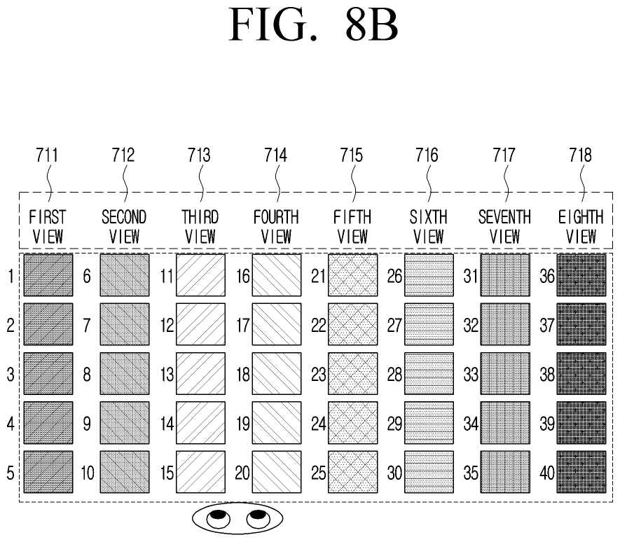

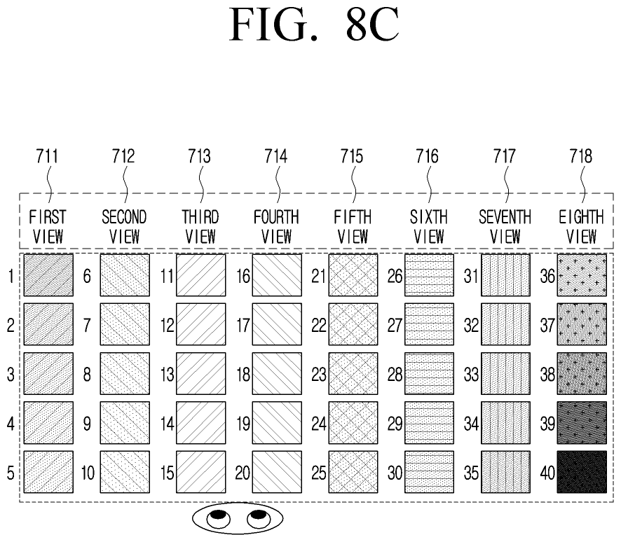

FIGS. 8A to 8C are views provided to explain a brightness adjustment method of an optical view according to an embodiment.

According to FIG. 8A, when the views recognized by the user's left and right eyes are the third view (713) and the fourth view (714), the electronic device 100 may adjust the brightness (or luminance) of the remaining views (711, 712, 715, 716, 717, 718) excluding the third view (713) and the fourth view (714) to a brightness darker than the brightness of the third view (713) and the fourth view (714). For example, the electronic device 100 may adjust the brightness of the remaining views excluding the third view (713) and the fourth view (714) to the same brightness at a ratio of 1/n (n is a number greater than 1) of the brightness of the third view (713) and the fourth view (714).

According to FIG. 8B, when the views recognized by the user's left and right eyes are the third view (713) and the fourth view (714), the electronic device 100 may adjust the brightness (or luminance) of the remaining views (711, 712, 715, 716, 717, and 718) excluding the third view (713) and the fourth view (714) to a brightness darker than the brightness of the third view (713) and the fourth view (714), but to a different brightness. For example, the electronic device 100 may provide a brightness that gradually decreases as it moves away from the third view (713) and the fourth view (714). For example, the electronic device 100 may adjust the brightness of the second view (712) and the fifth view (715) adjacent to the third view (713) and the fourth view (714) to a brightness at a ratio of 1/n1 (n1 is a number greater than 1) of the brightness of the third view (713) and the fourth view (714), and may adjust the brightness of the first view (711) and the sixth view (716) to a brightness at a ratio of 1/n2 (n2 is a number less than n1) of the brightness of the third view (713) and the fourth view (714). For example, the electronic device 100 may adjust the brightness of the views (711, 712, 715, 716, 717, 718) so that the brightness gradually decreases at the same ratio as they move away from the third view (713) and the fourth view (714).

According to FIG. 8C, when the views recognized by the user's left and right eyes are the third view (713) and the fourth view (714), the electronic device 100 may adjust the brightness (or luminance) of the sub-views constituting the remaining views (711, 712, 715, 716, 717, and 718) excluding the third view (713) and the fourth view (714) to a brightness darker than the brightness of the third view (713) and the fourth view (714), but to a different brightness. For example, the electronic device 100 may adjust the brightness of the ten sub-views (1 to 10) constituting the second view (712) and the first view (711) so that the brightness gradually decreases in sequence starting from the sub-view (10) adjacent to the third view (713). For example, the brightness may gradually decrease in the order of 10→9→8→7→6→5→4→3→2→1. For example, the electronic device 100 may adjust the brightness of the twenty sub-views (21 to 40) constituting the fifth view (715) to the eighth view (718) so that the brightness gradually decreases in sequence starting from the sub-view (21) closest to the fourth view (714). For example, the brightness may gradually decrease in the order of 21 →22→23 . . . →38→39→40.

In the above-described embodiments, the brightness values of the sub-views constituting a view are either all adjusted or all remain unadjusted, but this is merely an example, and even in the case of sub-views constituting the same view, some may have their brightness values adjusted and the others may not have their brightness values adjusted.

According to the various embodiments described above, it is possible to identify the user's viewing position in a glasses-free 3D display and provide an optimal 3D image. In addition, the brightness of the 3D image may be adjusted in positions other than the user's viewing position to limit the visibility of the image to others. Accordingly, privacy protection for the 3D image is possible.

An electronic device according to one or more embodiments disclosed herein may be provided in various forms. For example, the electronic device may include a portable communication device (e.g., a smartphone), a computing device, a portable multimedia device, a portable medical device, a camera, a wearable device, or a home appliance. The electronic device according to the embodiments of the present disclosure is not limited to the aforementioned devices.

The term “module” as used in one or more embodiments of the present disclosure may include a unit implemented in hardware, software or firmware, and may be used interchangeably with terms such as logic, logic block, component, or circuit. The module may be an integrally configured part or a minimum unit performing one or more functions or a part thereof. For example, the module may be implemented in the form of an application-specific integrated circuit (ASIC).

One or more embodiments of the present disclosure may be implemented as software (e.g.: program 140) including one or more instructions stored in a storage medium (e.g.: internal memory 136 or external memory 138) that can be read by a machine (e.g.: electronic device 101). For example, the machine (e.g.: processor 120 of the electronic device 101) may be a device that calls at least one instruction among one or more instructions stored in a storage medium and can execute them. This allows the device to perform at least one function according to the called at least one instruction. The one or more instructions may include a code that that is generated by a compiler or a code that can be executed by an interpreter. The machine-readable storage medium may be provided in the form of a non-transitory storage medium. Here, the term ‘non-transitory’ means that the storage medium is tangible without including a signal (e.g.: electromagnetic waves), and does not distinguish whether data are semi-permanently or temporarily stored in the storage medium.

According to an embodiment, the methods according to one or more embodiments may be included and provided in a computer program product. The computer program product may be traded as a product between a seller and a purchaser. The computer program product may be distributed in the form of a storage medium (e.g., compact disc read only memory (CD-ROM)) that is readable by devices, may be distributed through an application store (e.g., PlayStore™) or directly between two user devices (e.g., smartphones), or may be distributed online (e.g., by downloading or uploading). In the case of an online distribution, at least part of the computer program product may be at least temporarily stored in a storage medium readable by a machine such as a server of the manufacturer, a server of an application store, or the memory of a relay server or may be temporarily generated.

According to one or more embodiments, each of the above-described components (for example, modules or programs) may include a single entity or a plurality of entities, and some of the plurality of entities may be separated and placed in other components. According to one or more embodiments, one or more of the components or operations described above may be omitted, or one or more other components or operations may be added. Alternatively or additionally, a plurality of components (e.g., modules or programs) may be integrated into one component. In such a case, the integrated component may perform one or more functions of each of the plurality of components identically or similarly to those performed by the corresponding component among the plurality of components prior to the integration. According to one or more embodiments, operations performed by the modules, the programs, or the other components may be executed in a sequential manner, a parallel manner, an iterative manner, or a heuristic manner, or at least some of the operations may be performed in a different order or be omitted, or one or more operations may be added.

What is claimed is:

1. An electronic device comprising:
a display configured to provide a multi-view image including a plurality of images viewable from different viewpoints;
a sensor;
a memory to store instructions; and
at least one processor, including processing circuitry, to execute the instructions, which are stored in the memory, individually or collectively, to cause the electronic device to:
identify a viewing position of a user based on sensing data obtained through the sensor;
identify an image with a viewpoint corresponding to the viewing position of the user among the plurality of images viewable from the different viewpoints;
obtain an output image by adjusting a brightness of remaining images excluding images viewable from some viewpoints including the identified image; and
display the output image on the display.

2. The electronic device as claimed in claim 1, wherein the multi-view image includes the plurality of images viewable from the different viewpoints which are sequentially and repeatedly arranged; and
the at least one processor executes the instructions, individually or collectively, to cause the electronic device to:
adjust the brightness of remaining images excluding the identified image.

3. The electronic device as claimed in claim 2, wherein the at least one processor executes the instructions, individually or collectively, to cause the electronic device to:
obtain the output image by adjusting the brightness of the remaining images so that the brightness of the remaining images excluding the identified image is reduced.

4. The electronic device as claimed in claim 3, wherein the at least one processor executes the instructions, individually or collectively, to cause the electronic device to:
obtain the output image by adjusting the brightness of the remaining images so that the brightness gradually decreases in proportion to a distance from the identified image.

5. The electronic device as claimed in claim 3, wherein the at least one processor executes the instructions, individually or collectively, to cause the electronic device to:
obtain the output image by adjusting the brightness of the remaining images so that the brightness gradually decreases based on a weight that decreases according to a distance from the identified image; and
wherein a degree of decrease in the weight increases in proportion to a distance from the identified image.

6. The electronic device as claimed in claim 1, wherein the at least one processor executes the instructions, individually or collectively, to cause the electronic device to:
convert the remaining images from RGB color space images to YUV color space images;
maintain U and V values and adjust a Y value in the YUV color space images, and reconvert the YUV color space images with the adjusted Y value to RGB color images; and
obtain the output image based on the reconverted RGB color space images.

7. The electronic device as claimed in claim 1, wherein the at least one processor executes the instructions, individually or collectively, to cause the electronic device to:
output the output image by performing a blurring process while adjusting a brightness of the remaining images excluding some viewpoints including the identified image.

8. The electronic device as claimed in claim 1, wherein the at least one processor executes the instructions, individually or collectively, to cause the electronic device to:
based on a private mode being selected, obtain the output image by adjusting a brightness of remaining images excluding some viewpoints including the identified image.

9. The electronic device as claimed in claim 8, wherein the at least one processor executes the instructions, individually or collectively, to cause the electronic device to:
provide a user interface (UI) to allow a viewing angle to be set; and
identify remaining images excluding the identified image based on the viewing angle which is set through the UI in the private mode.

10. The electronic device as claimed in claim 1, wherein the display comprises:
a display panel configured to display the multi-view image including the plurality of images viewable from the different viewpoints; and
a viewing area separator, to be disposed in front of the display panel, and configured to provide an optical view corresponding to different viewpoints for each viewing area.

11. A controlling method of an electronic device including a display configured to provide a multi-view image including a plurality of viewable from different viewpoints, the controlling method comprising:
identifying a viewing position of a user based on sensing data obtained through a sensor;
identifying an image with a viewpoint corresponding to the viewing position of the user among a plurality of images viewable from the different viewpoints;
obtaining an output image by adjusting a brightness of remaining images excluding images viewable from some viewpoints including the identified image; and
displaying the output image on the display.

12. The controlling method as claimed in claim 11, wherein the multi-view image includes plurality of different images viewable from the different viewpoints which are sequentially and repeatedly arranged; and
wherein the obtaining the output image comprises adjusting the brightness of remaining images excluding the identified image.

13. The controlling method as claimed in claim 12, wherein the output image is obtained by adjusting a brightness of the remaining images so that the brightness of the remaining images excluding the identified image is reduced.

14. The controlling method as claimed in claim 13, wherein the output image is obtained by adjusting the brightness of the remaining images so that the brightness gradually decreases in proportion to a distance from the identified image.

15. The controlling method as claimed in claim 13, wherein the output image is obtained by adjusting the brightness of the remaining images so that the brightness gradually decreases based on a weight that decreases according to a distance from the identified image, and
wherein a degree of decrease in the weight increases in proportion to a distance from the identified image.

16. The controlling method as claimed in claim 11, wherein the obtaining the output image comprises:
converting the remaining images from RGB color space images to YUV color space images;
maintaining U and V values and adjust a Y value in the YUV color space images, and reconvert the YUV color space images with the adjusted Y value to RGB color images; and
obtaining the output image based on the reconverted RGB color space images.

17. The controlling method as claimed in claim 11, wherein the output image is obtained by performing a blurring process while adjusting a brightness of the remaining images excluding some viewpoints including the identified image.

18. The controlling method as claimed in claim 11, wherein the output image is obtained by adjusting a brightness of remaining images excluding some viewpoints including the identified image based on a private mode being selected.

19. The controlling method as claimed in claim 18, further comprises:
providing a user interface (UI) to allow a viewing angle to be set; and
identifying remaining images excluding the identified image based on the viewing angle which is set through the UI in the private mode.

20. A non-transitory computer readable recording medium storing a computer instruction executable by a processor of an electronic device including a display configured to provide a multi-view image including a plurality of images viewable from different viewpoints to cause the electronic device to:
identify a viewing position of a user based on sensing data obtained through a sensor;
identify an image with a viewpoint corresponding to the viewing position of the user among the plurality of images viewable from the different viewpoints;
obtain an output image by adjusting a brightness of remaining images excluding images viewable from some viewpoints including the identified image; and
display the output image on the display.
